(19) United States
(12) Patent Application Publication
(10) Pub. No.: US 2005/0243376 A1
(43) Pub. Date: Nov. 3, 2005

(54) Method and apparatus for half toning image

(75) Inventor: Sang-ho Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/046,683

(22) Filed: Feb. 1, 2005

(30) Foreign Application Priority Data
May 1, 2004 (KR) 10-2004-0030835

(51) Int. Cl. H04N 1/405; H04N 1/409

(52) U.S. Cl. 358/3.03; 358/3.27

(57) ABSTRACT

A method and apparatus for half-toning an image is provided having operations for transforming a gray scale image into a binary image, enhancing a resolution of the binary image using a resolution enhancement technology, and diffusing an error between the gray scale image and a resolution-enhanced binary image. Thus, resolution enhancement technology (RET) is accounted for in an image half-toning algorithm so that image forming apparatuses (for example, a printer or a multi-function machine), or displays to which the RET is applied, can output an image of optimal quality.

### CROSS-REFERENCE TO RELATED APPLICATIONS

This application claims the benefit under 35 U.S.C. §119(a) of Korean Patent Application No. 10-2004-0030835, filed in the Korean Intellectual Property Office on May 1, 2004, the entire contents of which are hereby incorporated by reference.

### BACKGROUND OF THE INVENTION

1. Field of the Invention

The present invention relates to half toning of an image used in the field of image forming apparatuses or displays. More particularly, the present invention relates to a method and apparatus for half toning an image, in which a resolution enhancement technology (RET) is accounted for in a half toning algorithm.

2. Description of the Related Art

In the current field of image forming apparatuses or displays, examples of an algorithm for directly producing or dealing with a binary image includes half toning technology and resolution enhancement technology (RET).

In half toning technology, a gray-scale image is transformed into a binary image. Such half toning technology is widely used in the field of image forming apparatuses and displays, such as printers, multi-functional machines, and the like, that can display a pixel using only an on-off operation.

In resolution enhancement technology, when a binary image is transferred from a computer to an image forming apparatus, the binary image is manipulated to increase the quality of the binary image. For example, a diagonal line or a gray level of the binary image is smoothed.

Half toning technology further includes an error diffusion technique or a technique using a visual filter.

FIG. 1 is a block diagram of a conventional apparatus for half toning an image using an error diffusion technique. The conventional apparatus includes a threshold value comparator 10 for reading a gray scale image f[m,n] and comparing a pixel value of the gray scale image f[m,n] with a predetermined threshold value. The conventional apparatus further includes a brightness value corrector 20, which is generally referred to as a printer dot model filter, for correcting a binary image to have a brightness value of a real image output by an image forming apparatus, and an error diffuser 30 for diffusing errors in the gray scale image and the binary image.

When an image u[m,n], which is an update of the gray scale image f[m,n], is smaller than the predetermined threshold value, a brightness value of “0” (that is, a black dot) is output. When the image u[m,n] is greater than the predetermined threshold value, a brightness value of “1” (that is, a white dot) is output. A binary image g[m,n] obtained in such a manner, then passes through the brightness value corrector 20 and is corrected into an image p[m,n] having a brightness value of a real image to be displayed on an image forming apparatus. An error signal e[m,n] corresponding to a difference between the images p[m,n] and u[m,n] is diffused with the gray scale image f[m,n], so that the gray scale image f[m,n] is turned into the updated gray scale image u[m,n].

FIG. 2 is a block diagram of a conventional apparatus for half-toning an image using visual filters 70. The conventional apparatus includes a threshold value comparator 50 for reading a gray scale image f[m,n] and comparing the same with a predetermined threshold value, a brightness value corrector 60 for correcting a binary image into a real brightness value of an image forming apparatus, the visual filters 70 for performing filtering corresponding the sense of human sight, a filtering value calculator 80 for calculating a difference between filtering values of the binary image and the gray scale image filtered by the visual filters 70, a convergence determiner 85 for determining whether a value calculated by the filtering value calculator 80 is no more than a predetermined threshold value, and a binary image corrector 90 for correcting data of the binary image depending on a result of the determination by the convergence determiner 85.

Operations of the threshold value comparator 50 and the brightness value corrector 60 are the same as those of the threshold value comparator 10 and the brightness value corrector 20 of FIG. 1. A binary image p[m,n], to which a binary image g[m,n] is connected by the brightness value corrector 60, is filtered by the visual filter 70 and output as a filtered image q[m,n] that can be recognized by human eyes. The gray scale image f[m,n] is filtered by the visual filter 70 and output as a filtered image k[m,n] that can also be recognized by human eyes. The filtering value calculator 80 calculates a sum of a difference between filtered images g[m,n] and k[m,n]. To minimize the sum, the binary image corrector 90 corrects the binary image g[m,n] output by the threshold value comparator 50 in an optimal way in response to the result of the determination by the convergence determiner 85.

This process is repeated to converge the sum of the difference between filtered images g[m,n] and k[m,n] obtained by the filtering value calculator 80 to no more than a predetermined threshold value. When the sum of the difference between filtered images g[m,n] and k[m,n] is converged to no more than the predetermined threshold value, the binary image g[m,n] is considered to be an optimal binary image.

When a binary image is obtained using the error diffusion technique or using visual filters designed to optimize the quality of the binary image, and the half toned binary image is transformed using resolution enhancement technology to improve the resolution of an image forming apparatus, the quality of the binary image is not optimal because the binary image is transformed in a resolution enhancement module even when an optimal binary image is produced by a half toning module. Consequently, even when an optimal binary image is produced in a half toning process, the quality of the binary image is degraded while a resolution enhancement algorithm is being performed.

Accordingly, a need exists for a system and method for half-toning an image using resolution enhancement technology together with an image half-toning algorithm, so that an image forming apparatus can output an image of optimal quality.

### SUMMARY OF THE INVENTION

The present invention provides a method and apparatus for half-toning an image, in which, resolution enhancement technology (RET) is accounted for in an image half toning algorithm.

According to an aspect of the present invention, an image half-toning method is provided comprising the steps of transforming a gray scale image into a binary image, enhancing a resolution of the binary image using the RET, and diffusing an error between the gray scale image and a resolution-enhanced binary image.

According to another aspect of the present invention, an image half-toning apparatus is provided comprising a threshold value comparator for transforming a gray scale image into a binary image, a resolution enhancer for enhancing a resolution of the binary image, and an error diffuser for diffusing an error between the gray scale image and a resolution-enhanced binary image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for half-toning an image using an error diffusion technique;

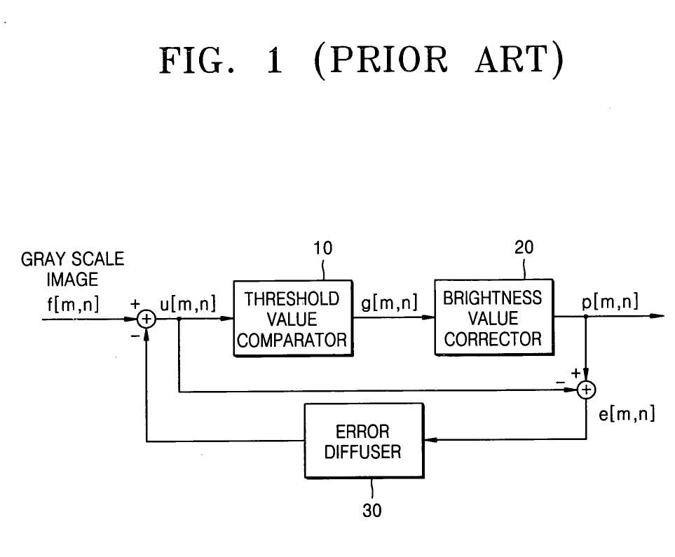

FIG. 2 is a block diagram of a conventional apparatus for half-toning an image using visual filters;

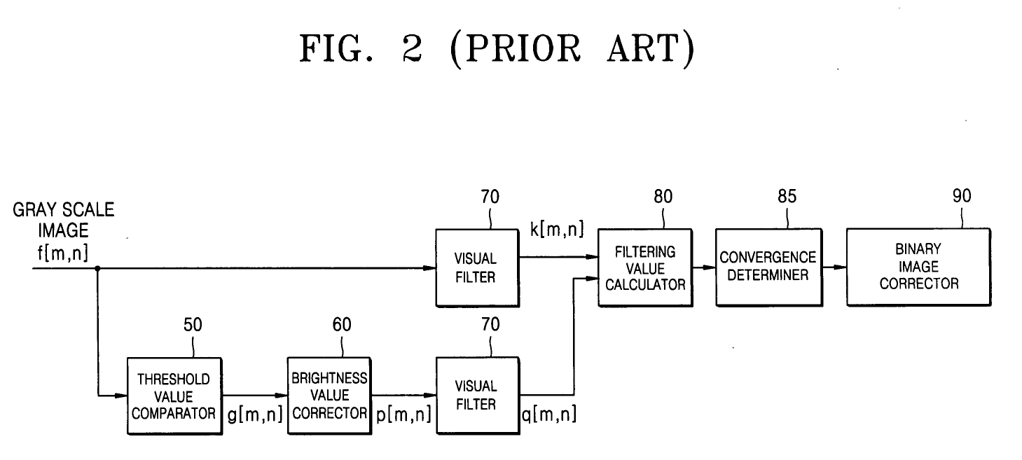

FIG. 3 is a flowchart illustrating an image half toning method according to an embodiment of the present invention;

FIG. 4 is a flowchart illustrating an image half toning method according to another embodiment of the present invention;

FIG. 5 is a block diagram of an image half toning apparatus according to an embodiment of the present invention; and

FIG. 6 is a block diagram of an image half toning apparatus according to another embodiment of the present invention.

Throughout the drawings, like reference numerals will be understood to refer to like parts, components and structures.

### DETAILED DESCRIPTION OF EXEMPLARY EMBODIMENTS

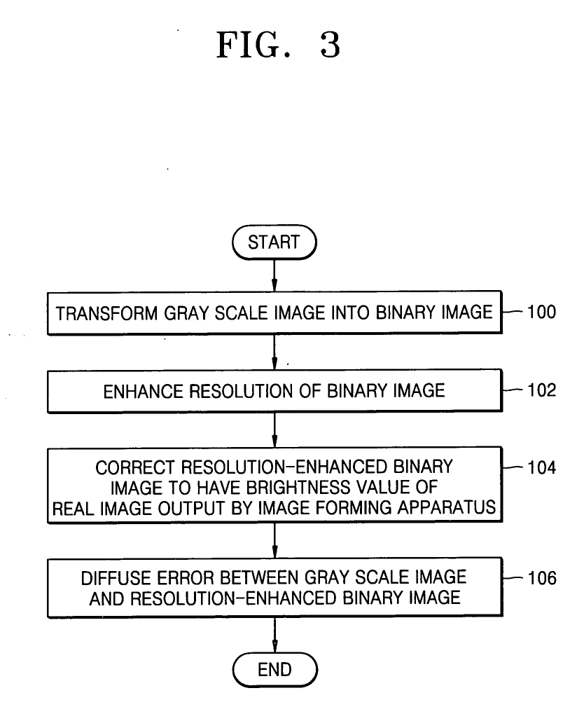

FIG. 3 is a flowchart illustrating an image half-toning method according to an embodiment of the present invention. The method of FIG. 3 includes operations 100 through 106, for correcting a brightness value of a binary image with an improved resolution.

First, in operation 100, a gray scale image is transformed into a binary image. The gray scale image is obtained by representing an original image in a gray value brightness of between 0 and 256. The gray scale image can be represented in only 256 shades, so if an image having colors exceeding 256 shades is transformed into a gray scale image, the image is reduced to an 8-bit image.

The binary image is then processed as either black or white depending on whether pixel values of the gray scale image are either greater than or less than a threshold value.

In operation 102, a resolution of the binary image is improved using resolution enhancement technology (RET). In the RET, a binary image is manipulated for improvements, such as smoothing a diagonal or a gray level of a binary image, to increase the quality of the binary image. Also, the RET is achieved by precisely controlling a size of a dot dropped to a curved part of an image and a location where the dot is dropped. For example, in a color resolution enhancement technology (C-RET), a color is adjusted using a change in the size of a dot and ink mixture so that a light and a shade can be more clearly and smoothly distinguished from each other.

In operation 104, the resolution-enhanced binary image is corrected to have a brightness value of a real image output by an image forming apparatus. Under ideal conditions, a binary image having an arbitrary brightness value must be output as an image having the same brightness value as that of the real image output by the image forming apparatus. However, it is difficult in practice to provide binary image outputs using various image forming apparatuses while keeping identical brightness values. Hence, a process can be required for correcting errors between brightness values of the binary image and the real image output by the various image forming apparatuses. In operation 104, the errors between the brightness values of the binary images and the real images output by the various image forming apparatuses are corrected.

In operation 106, an error between the gray scale image and the resolution-enhanced binary image is diffused.

Error diffusion denotes the diffusion of a quantization error due to a binarization of a pixel to neighboring pixels. Due to the error diffusion, a high quality image having a clear boundary can be obtained.

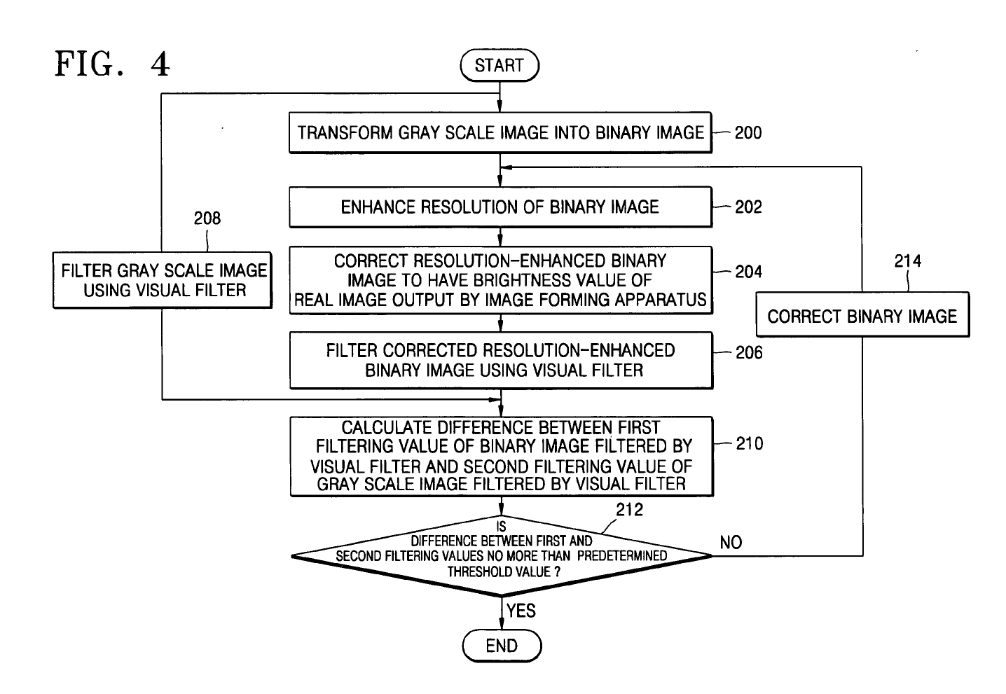

FIG. 4 is a flowchart illustrating an image half-toning method according to another embodiment of the present invention. The method of FIG. 4 includes operations 200 through 214, for calculating a difference between filtering values of a binary image and a gray scale image filtered by visual filters.

First, in operation 200, the gray scale image is transformed into the binary image.

In operation 202, a resolution of the binary image is then improved using the RET. Since the RET operation is substantially the same as that described in operation 102, a detailed description thereof will be omitted.

In operation 204, the resolution-enhanced binary image is corrected to have a brightness value of a real image output by an image forming apparatus. Since operation 204 is substantially the same as operation 104 described above, a detailed description thereof will be omitted.

In operation 206, the resolution-enhanced binary image is filtered by one of the visual filters corresponding to human eyes. Each of the visual filters performs a function corresponding to the sense of sight. That is, while the binary image is passing through one of the visual filters, it turns into an image as sensed by the eyes of a human.

In operation 208, the gray scale image is filtered in parallel by the other visual filter, and is forwarded to the operation 210 for a comparison with the results of the operation 206.

Operations 206 and 208 are followed by operation 210 for calculating a difference between a first filtering value of the binary image filtered by one of the visual filter, and a second filtering value of the gray scale image filtered by the other visual filter. The first filtering value is obtained by filtering the binary image in step 206, and the second filtering value is obtained by filtering the gray scale image in step 208. Squares of differences between the first and second filtering values are summed.

In operation 212, it is then determined whether the difference between the first and second filtering values is no more than a predetermined threshold value. Specifically, it is determined whether the sum of the squares of the differences between the first and second filtering values is less than or equal to the predetermined threshold value. If the difference between the first and second filtering values is less than or equal to the predetermined threshold value, the method is concluded.

If the difference between the first and second filtering values is greater than the predetermined threshold value, data of the binary image is corrected in operation 214, which is followed by operation 202. To converge the difference between the first and second filtering values to no more than a predetermined value, operations 202 through 214 can be repeated to correct a binary image to an optimal binary image.

In the embodiment shown in FIG. 4, an optimal binary image cannot be obtained until the difference between the first and second filtering values is converged to no more than a predetermined value,

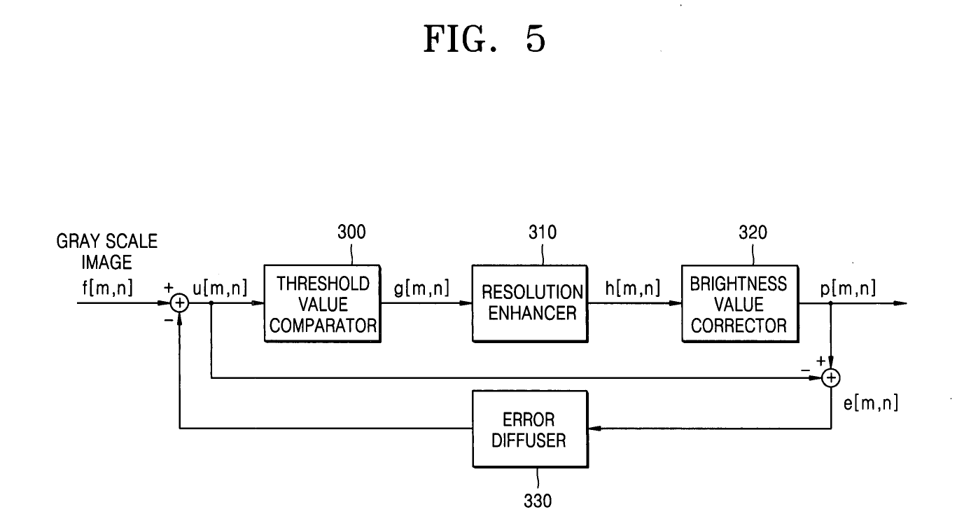

FIG. 5 is a block diagram of an image half toning apparatus according to an embodiment of the present invention. The apparatus of FIG. 5 includes a threshold value comparator 300, a resolution enhancer 310, a brightness value corrector 320, and an error diffuser 330.

The threshold value comparator 300 transforms a gray scale image f[m,n] into a binary image g[m,n]. More specifically, the threshold value comparator 300 reads a gray scale image u[m,n], which is an update to the gray scale image f[m,n], and compares a pixel value of the image u[m,n] with a predetermined threshold value. The threshold value comparator 300 outputs the binary image g[m,n], which is produced depending on a result of the comparison, to the resolution enhancer 310.

The resolution enhancer 310 enhances a resolution of the binary image g[m,n] using the RET. More specifically, the resolution enhancer 310 enhances the resolution of the binary image g[m,n] received from the threshold value comparator 300 and outputs a resolution-enhanced binary image h[m,n] to the brightness value corrector 320.

The brightness value corrector 320 is typically referred to as a printer dot model filter and corrects the resolution-enhanced binary image h[m,n] to have a brightness value of a real image output by an image forming apparatus. More specifically, the brightness value corrector 320 receives the resolution-enhanced binary image h[m,n] from the resolution enhancer 310, corrects a brightness value of the binary image h[m,n] depending on the type of image forming apparatus, and outputs a brightness-corrected binary image p[m,n].

The error diffuser 330 diffuses errors in the gray scale image f[m,n] and the brightness-corrected binary image p[m,n]. More specifically, when the error diffuser 330 receives an error e[m,n] between the brightness-corrected binary image p[m,n] and the updated gray scale image u[m,n], the error diffuser 330 diffuses the error e[m,n] to the original gray scale image f[m,n]. Due to the error diffusion by the error diffuser 330, the original gray scale image f[m,n] turns into the updated gray scale image u[m,n]. In the embodiment of FIG. 5, the error diffuser 330 is a low frequency band filter.

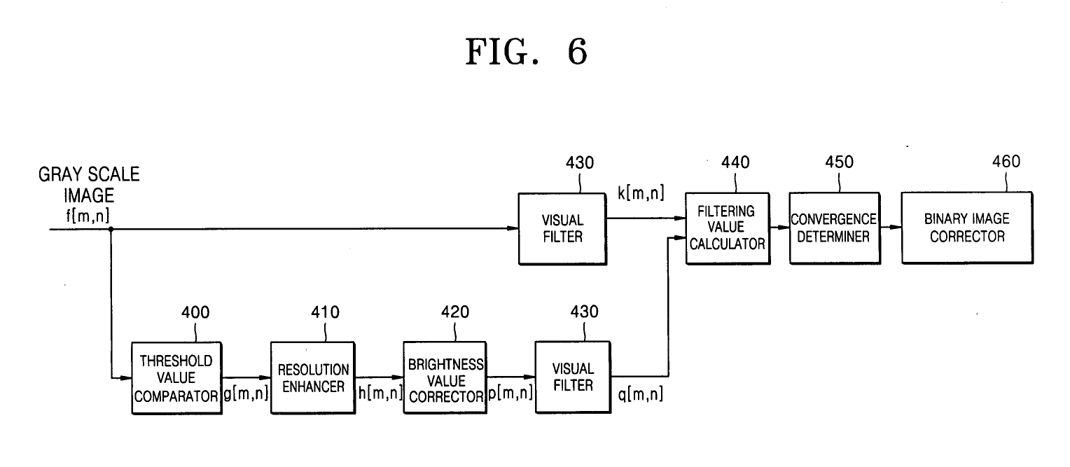

FIG. 6 is a block diagram of an image half toning apparatus according to another embodiment of the present invention. The apparatus of FIG. 6 includes a threshold value comparator 400, a resolution enhancer 410, a brightness value corrector 420, parallel visual filters 430, a filtering value calculator 440, a convergence determiner 450, and a binary image corrector 460.

The threshold value comparator 400 transforms the gray scale image f[m,n] into the binary image g[m,n]. More specifically, the threshold value comparator 400 reads the gray scale image f[m,n], compares the pixel value of the gray scale image f[m,n] with the predetermined threshold value, and outputs the binary image g[m,n] to the resolution enhancer 410.

The resolution enhancer 410 enhances a resolution of the binary image g[m,n]. More specifically, the resolution enhancer 410 enhances the resolution of the binary image g[m,n] received from the threshold value comparator 400 and outputs a resolution-enhanced binary image h[m,n] to the brightness value corrector 420.

The brightness value corrector 420 corrects the resolution-enhanced binary image h[m,n] to have a brightness value of a real image output by an image forming apparatus. More specifically, the brightness value corrector 420 receives the resolution-enhanced binary image h[m,n] from the resolution enhancer 410, corrects a brightness value of the binary image h[m,n] depending on the type of image forming apparatus, and outputs a brightness-corrected binary image p[m,n].

Each of the visual filters 430 performs filtering corresponding the sense of sight of human eyes. More specifically, the brightness-corrected binary image p[m,n] passes through one of the visual filters 430 and turns into an image as sensed by the eyes of a human. In other words, the brightness-corrected binary image p[m,n] passes through one of the visual filters 430 and then turns into a filtered image q[m,n]. The gray scale image f[m,n] passes through the other visual filter 430 and then turns into a filtered image k[m,n].

The filtering value calculator 440 calculates a difference between a first filtering value of the binary image q[m,n] filtered by one of the visual filters 430, and a second filtering value of the gray scale image k[m,n] filtered by the other visual filter 430, and outputs a result of the calculation to the convergence determiner 450. That is, the filtering value calculator 440 calculates a sum of differences between the first and second filtering values.

The convergence determiner 450 determines whether a value calculated by the filtering value calculator 440 is greater than or less than the predetermined threshold value and outputs a result of the determination to the binary image corrector 460.

In response to the result of the determination, the binary image corrector 460 corrects data of the binary image g[m,n], which is output by the threshold value comparator 400, to provide an optimal binary image.

The binary image corrected by the binary image corrector 460 can be repeatedly passed through the resolution enhancer 410, the brightness value corrector 420, the visual filters 430, the filtering value calculator 440, and the convergence determiner 450 so that the difference between the first and second filtering values is converted to no more than the predetermined threshold value.

In the embodiment shown in FIG. 6, an optimal binary image cannot be obtained until the difference is converged to no more than the predetermined threshold value.

As described above, a method and apparatus for half-toning an image according to the present invention uses the RET together with an image half-toning algorithm so that an image forming apparatus (for example, a printer or a multi-function machine) to which the RET is applied, can output an image of optimal quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image half toning method comprising the steps of:
transforming a gray scale image into a binary image;
enhancing a resolution of the binary image using a resolution enhancement technology; and
diffusing an error between the gray scale image and a resolution-enhanced binary image.

2. The image half toning method of claim 1, further comprising the step of:
correcting the resolution-enhanced binary image to have a brightness value of a real image output by an image forming apparatus prior to the step of diffusing the error between the gray scale image and a resolution-enhanced binary image.

3. An image half toning method comprising the steps of:
transforming a gray scale image into a binary image;
enhancing a resolution of the binary image using a resolution enhancement technology;
filtering the resolution-enhanced binary image using a first visual filter; and
calculating a difference between a first filtering value of the binary image filtered by the first visual filter and a second filtering value of the gray scale image filtered by a second visual filter.

4. The image half toning method of claim 3, wherein the first and second visual filter are configured to correspond to a sense of human eyesight.

5. The image half toning method of claim 3, further comprising the step of:
correcting the resolution-enhanced binary image to have a brightness value of a real image output by an image forming apparatus prior to the step of filtering the resolution-enhanced binary image.

6. An image half toning apparatus comprising:
a threshold value comparator for transforming a gray scale image into a binary image;
a resolution enhancer for enhancing a resolution of the binary image; and
an error diffuser for diffusing an error between the gray scale image and a resolution-enhanced binary image.

7. The image half toning apparatus of claim 6, further comprising a brightness value corrector for correcting the resolution-enhanced binary image to have a brightness value of a real image output by an image forming apparatus.

8. An image half toning apparatus comprising:
a threshold value comparator for transforming a gray scale image into a binary image;
a resolution enhancer for enhancing a resolution of the binary image;
a plurality of visual filters for performing filtering corresponding to a sense of human eyesight; and
a filtering value calculator for calculating a difference between a first filtering value of the binary image filtered by one of the visual filters and a second filtering value of the gray scale image filtered by another visual filter.

9. The image half toning apparatus of claim 8, further comprising a brightness value corrector for correcting the resolution-enhanced binary image to have a brightness value of a real image output by an image forming apparatus.
